(19) United States
(12) Patent Application Publication
(10) Pub. No.: US 2026/0323374 A1
(43) Pub. Date: Oct. 15, 2026

(54) METHODS, ARCHITECTURES, APPARATUSES AND SYSTEMS FOR MANAGING RESOURCE CONFLICTS

(71) Applicant: InterDigital Patent Holdings, Inc., Wilmington, DE (US)

(72) Inventors: Achref Methenni, Montreal (CA); Michael Starsinic, Newtown, PA (US); Samir Ferdi, Kirkland (CA); Rocco Di Girolamo, Laval (CA); Magurawalage Chathura Madhusanka Sarathchandra, London (GB); Xavier De Foy, Kirkland (CA); Ulises Olvera-Hernandez, Saint-Lazare (CA)

(21) Appl. No.: 19/483,062

(22) PCT Filed: May 10, 2024
(86) PCT No.: PCT/US2024/028811

§ 371 Date: Nov. 10, 2025

Related U.S. Application Data
(60) Provisional application No. 63/465,577, filed on May 11, 2023.

(51) Int. Cl. H04W 28/02

(52) U.S. Cl. CPC H04W 28/0268

(57) ABSTRACT

In a demanding wireless networking environment where access to interdependent different network services is required simultaneously, a coordination in the network supporting these different services is useful for improving the user experience when the access to these different services at a same time may cause resource conflicts. A WTRU may therefore indicate to the network that a dependency check may be required for a PDU session, in case configuration of a PDU session is to be coordinated with the configuration of other PDU session(s) in the WTRU.

### CROSS-REFERENCE TO RELATED APPLICATIONS

This application claims the benefit of U.S. Provisional Patent Application No. 63/465,577 filed May 11, 2023, which is incorporated herein by reference.

### BACKGROUND

The present disclosure is generally directed to the fields of communications, software and encoding, including, for example, to methods, architectures, apparatuses, systems related to management of resource conflicts.

### SUMMARY

Access to multiple services in a network at a same time may be desirable. An example use case is that of a metaverse. A metaverse is a shared virtual space that people access via the internet, where they can create and interact with 3D avatars and objects using VR or AR devices. The term “metaverse” comes from a 1992 science fiction novel and means “meta” and “universe”.

A user in the metaverse may perform multiple activities, and each activity may require access to different services. These different services may depend on each other and access to these different services may be required at a same time. The simultaneous access to different services may cause resource conflicts in a user terminal and/or in the network. It is therefore desirable to support a coordination in the network supporting these different services for improving the user experience.

Embodiments are disclosed, described and claimed in the appended claims, which embodiments contribute to providing simultaneous access to multiple services.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a procedure of coordination during protocol data unit (PDU) session establishment according to an embodiment;

FIG. 3 is a flowchart of a method according to an embodiment, wherein a WTRU indicates that a dependency check is required for a PDU session;

FIG. 4 is a session management (SM) policy association establishment with dependency check; and

FIG. 5 is a flow chart of a method according to an embodiment, wherein a policy control function (PCF) performs a dependency check on policy charging and control (PCC) rules, service parameters, or parameter sets.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### ABBREVIATIONS AND ACRONYMS

5GS 5G System
AF Application Function
AMF Access and Mobility Function
ANDSP Access Network Discovery and Selection Policy
AT Attention
BSF Binding Support Function
CRF Coordination Function
DNN Data Network Name
ID Identifier
NAS Non-Access Stratum
NEF Network Exposure Function
NF Network Function
NRF Network Repository Function
NG-RAN Next Generation Radio Access Network
PCC Policy Charging and Control
PCF Policy Control Function
PDU Protocol Data Unit
QoS Quality of Service
RAN Radio Access Network
SM Session Management
SMF Session Management Function
SUPI Subscription Permanent Identifier
S-NSSAI Single Network Slice Selection Assistance Information
UDR Unified Data Repository
UE User Equipment (see WTRU)
URSP UE Route Selection Policy
VR Virtual Reality
WTRU Wireless Transmit-Receive Unit (see UE)
XR Extended Reality
XRM Extended and Multimodal Reality

### Example Communications System

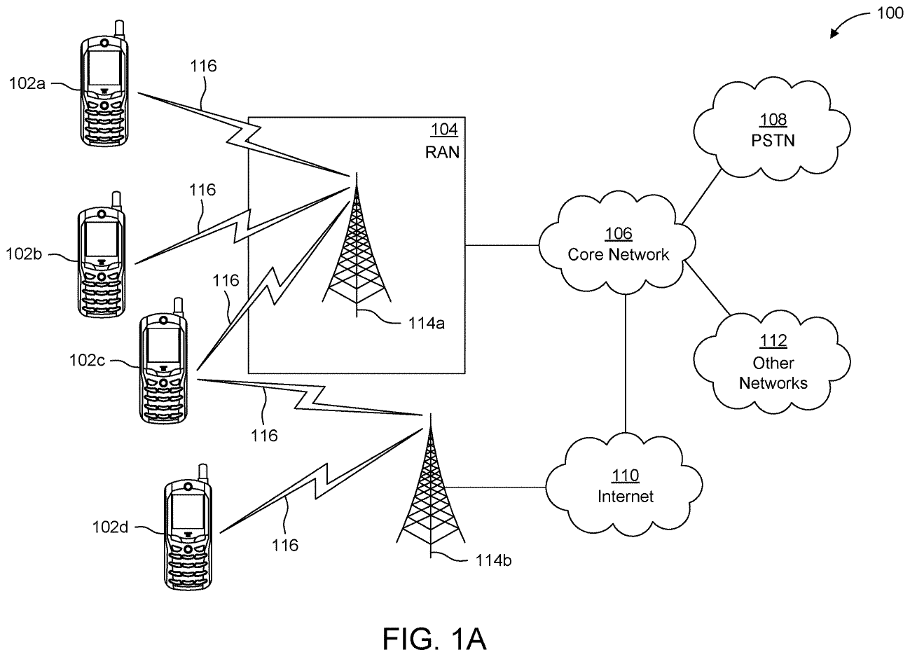

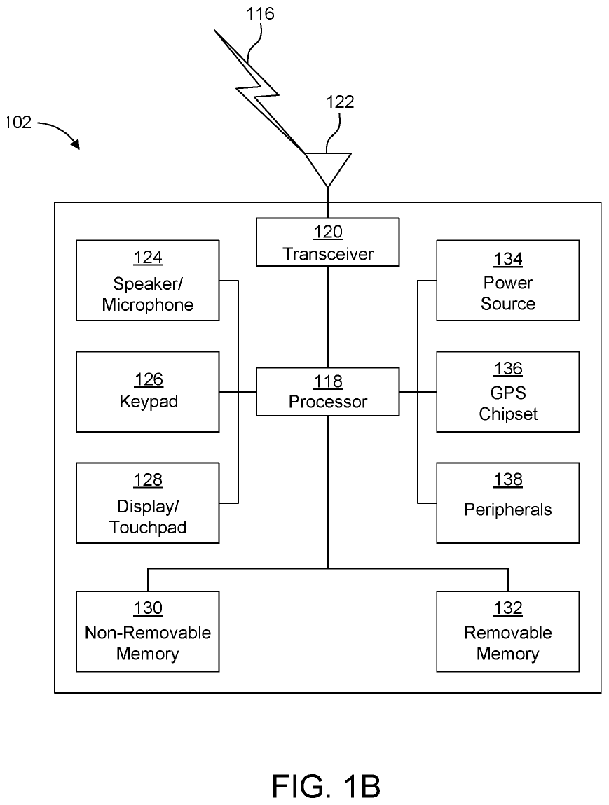

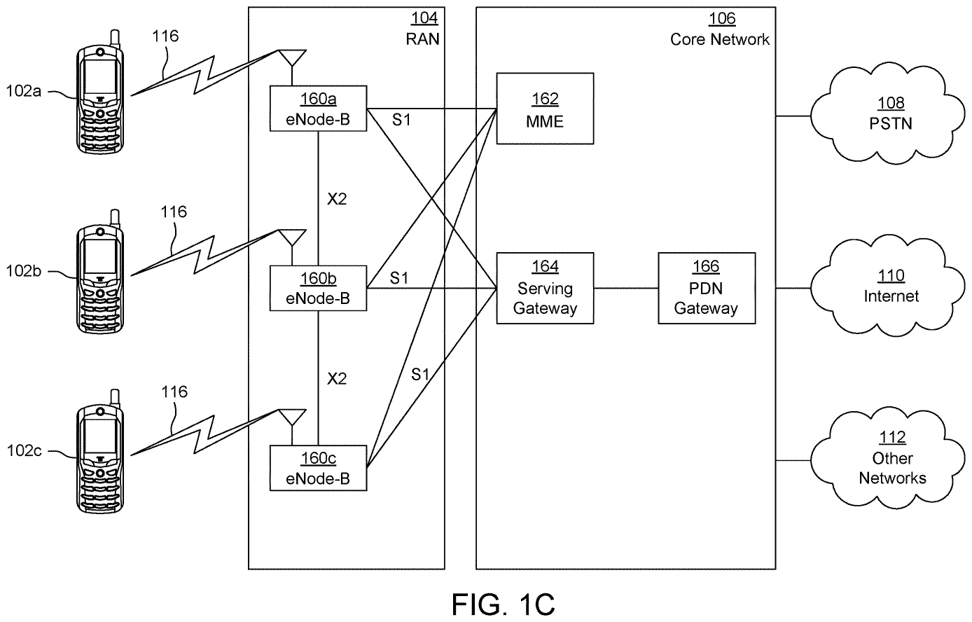

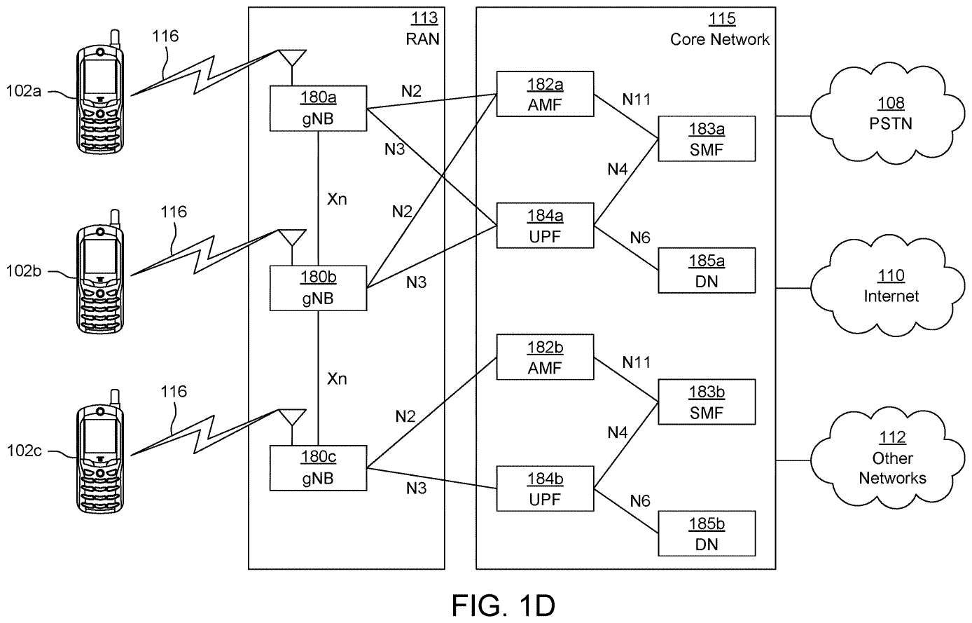

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the SI interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In a use case regarding coordination between multiple services in the metaverse, a metaverse user, named John, performs multiple activities in the metaverse. Each activity requires access to different services. John is equipped with immersive experience devices, including VR glasses and a pair of Tactile gloves. The immersive experience devices are used to access the different services. For example, John receives audio from different services through either an audio device (e.g., earphone) or a built-in audio system in the VR glasses.

John can perform different activities that are each supported by one of the two services. A first activity may be a streaming live immersive content, where John enjoys video streaming through the VR glasses as well as audio input of a concert. A second activity may be performing an immersive painting activity, where John uses the tactile gloves to feel the sensation of painting as well as the VR glasses to see the painting as it progresses.

John might perform both activities at the same time, for example he may watch the live immersive concert and perform the painting at the same time. Simultaneously using both services might cause a conflict between the two services. For example, each individual service might demand an appropriate amount of network resources from the slice that provides the service, but the WTRU might not be able to consume the aggregate amount of resources that are required by all (i.e. both) services. The WTRU may not be able to consume the aggregate amount of resources because, for example, the WTRU's transceiver may not be capable of sending or receiving the necessary aggregate uplink or downlink data rate. In another example, the network might not be capable of providing the necessary aggregate uplink or downlink data rate to the WTRU. In other example, network policies may be that the WTRU should not be permitted to send or receive the necessary aggregate uplink or downlink data rate.

Currently there is no support for a mechanism to detect that different services which are provided to the same WTRU, by different network slices, may be dependent on each other. Coordination methods between the two services are needed so that a good user experience is maintained or achieved. It is therefore desirable for the 5GS to be able to support the coordination between the network slices that provide such services, e.g., to provide a mechanism to support how to adjust the policies of one service of the metaverse, if policies of the other service to which it is related to have changed or need to be adjusted. 5G system enhancements are desired to provide the capability of coordination between different mobile metaverse services to prevent poor user experience due to conflicting XR media.

Coordination between PCC rules can be regarded as a type of conflict handling between PCC rules.

### Overview

In the following sections, we will assume that a WTRU may be exchanging data traffic for two XRM services. One service may be called service A and may be accessible via a network slice named Slice A. The other service may be called service B and may be accessible via a network slice named Slice B. In each slice, for the WTRU to be able to exchange traffic with an application server, a PDU session needs to be established between the WTRU and the 5G core network. During the PDU session establishment process, a PCF for the PDU session is selected. For each slice A and B, the PCFs for the PDU session may be different.

We assume that these two PCFs do no communicate with each other directly. Maintaining a certain amount of isolation between the PCFs is aligned with the principles of network slicing. In fact, the PCFs may not be aware of each other.

In the following sections, we describe solutions that allow for the PCFs for the PDU session in each network slice to exchange information with a network function for the purpose of coordination/conflict handling.

For a better understanding of the following sections, the following is useful:

Once a WTRU is registered to the network, the 5GS selects a PCF for the WTRU for Access and mobility management policies.

Application traffic in the WTRU may be ready to be sent to an application server. Before that, once the WTRU is registered in the network, the 5GS selects a PCF for the WTRU for Access and mobility management policies.

The WTRU prepares to create a data session, called PDU session so that the traffic related to this application can be transmitted to the network and forwarded to the application server.

The PDU session that serves the WTRU for a particular service is associated with a slice.

During WTRU requested PDU session establishment procedure, the WTRU sends a NAS message to the serving AMF. The AMF performs SMF selection based on information regarding the WTRU. For example, if the WTRU provided a DNN/S-NSSAI combination in the message, the AMF select an SMF that serves the WTRU within this DNN/S-NSSAI combination.

The SMF then select a PCF that serves the WTRU for the PDU session. This PCF is tasked to, for example, generate PCC rules for the data service for the WTRU.

### Dependency Check between two XRM services

A PCF that serves a PDU Session creates PCC Rules for the PDU Session. The PCC Rules may be created during a PDU Session Establishment procedure. The PCC Rules may be modified during a PDU Session Modification procedure. The PCC Rules may also be modified outside of a PDU Session Modification procedure. The PCF sends the PCC Rules to the SMF. The SMF uses the PCC Rules to:
create N4 Rules that the SMF sends to the UPF;
create a QoS Profile that is sent to the RAN Node; and create QOS Rules that are sent to the WTRU.

As described herein, the PCF that serves the PDU Session may not be aware of PDU Sessions that the WTRU has established in other network slices and is not able to consider the needs, or requirements, of services that are provided by other network slices when the PCF that serves the PDU Session creates, or modifies, PCC Rules.

This section describes example procedures that the PCF that serves a PDU Session may use to coordinate PCC Rule creation or modification. The coordination operation considers the requirements, or needs, of services that are provided to the WTRU by other network slices.

As mentioned previously, coordination between PCC rules can be regarded as a type of conflict handling between PCC rules.

These example procedures introduce a coordination function (CRF) that coordinates PCC Rule creation, and modification, across network slices. Coordinating PCC Rule creation, and modification, across network slices means that the PCF that serves a PDU Session may send a desired set of PCC Rules to the CRF. The CRF may evaluate the desired set of PCC Rules with other sets of PCC Rules that are related to other PDU Sessions of the same WTRU. The CRF may then:
reply with an indication of whether or not PCF may use the desired PCC Rules;
include a set of PCC Rules in the reply that may be used by the PCF; or
send a notification to a second PCF that is serving a WTRU's second PDU Session of a second network slice to inform the second PCF that the second PCF needs to change the PCC Rules that are used for the WTRU's second PDU Session of a second network slice.

An architectural advantage of using a CRF is that the PCFs that serve a WTRU's PDU Session can be isolated from one another. Isolation may be desirable because the PCFs are part of different network slices. The task of prioritizing services that are provided by different network functions may be kept separate from any individual network slice. Since the CRF interacts with PCFs of multiple network slices, a CRF instance logically belongs to each Network Slice that it interacts with, i.e., this CRF instance is common to the Network Slice. By assigning the task of coordinating between network slices to a single NF (i.e., the CRF), the number of network functions that need to interact with multiple slices is minimized.

The CRF may be a PCF or in other words the CRF functionality may be included in a PCF. For example, the CRF may be the PCF that serves the WTRU for Access and Mobility Policies (i.e., the PCF that sends URSP and ANDSP Rules to the WTRU). In other words, the functionality described herein as applying to the CRF may be performed by the PCF that serves the WTRU for Access and Mobility Policies.

The CRF may be a BSF. In other words, the functionality described herein as applying to the CRF may be performed by a BSF.

The CRF may be a new network function that provides services to the other PCFs.

### Dependency Check Between Two XRM Services: Coordination Between Two Services

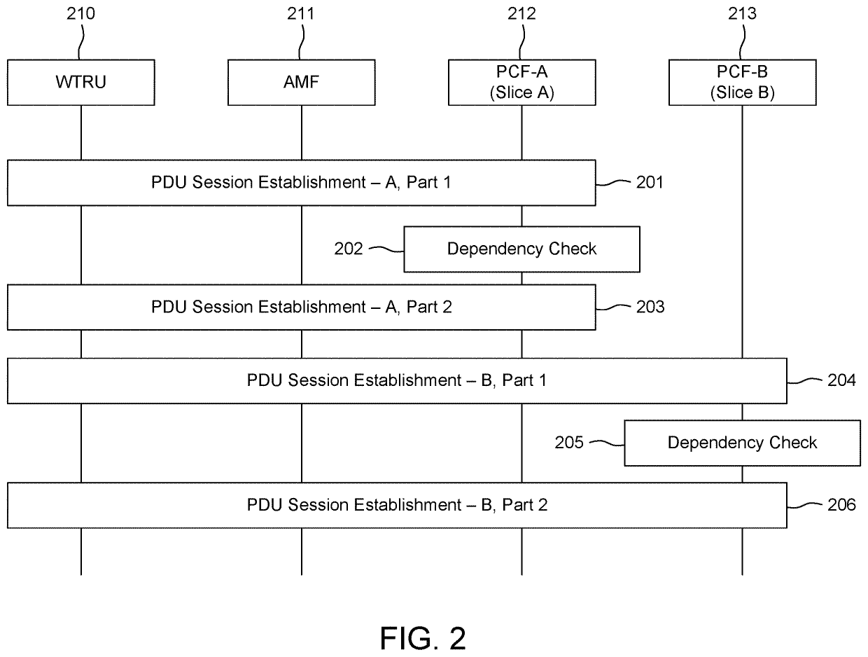

FIG. 2 is a procedure of coordination during PDU session establishment according to an embodiment.

In this figure, two XRM services are established for a WTRU (210), and the PCF that serves each PDU Sessions of each service (PCF-A 212, PCF-B 213) checks if its PCC rules conflict with the configuration of other services of the WTRU (i.e., the PCFs check if each of their PCC rules conflict with the PCC Rules of other services of the WTRU).

In 201, the WTRU and network begin to perform a PDU session establishment procedure for service A. This procedure encompasses: the WTRU sending a PDU session establishment request message to the 5GS, i.e., AMF; when the AMF receives the WTRU request, it performs an SMF selection to select the SMF-A that will serve the WTRU for the PDU session; and the SMF-A will then perform a PCF selection based on information provided by the WTRU such as the S-NSSAI/DNN combination. At this point the SMF is about to start an SM policy association establishment procedure with the PCF-A.

The WTRU may include information in the PDU Session Establishment Request such as a DNN and an S-NSSAI that is associated with the PDU Session and associated with accessing service A. The WTRU may also include PDU session conflict assistance information. The PDU session conflict assistance information may include the identity of a CRF or a parameter that can be used to determine an identity of a CRF in the PDU Session Establishment Request. The PDU session conflict assistance information may also include a preference level indication that indicates the preference level of the PDU Session. The WTRU may determine the preference level of the PDU Session based on information that is received from an application via an AT Command or graphical user interface. The preference level may be a priority value (for example, a numeric value or a relative priority indication such as “low”, “medium”, or “high”). The WTRU may determine the priority value for the PDU session, by setting this value to the Priority Level associated with the PDU session's QoS flow that has the highest priority. The PDU session conflict assistance information may also provide an indication if the network may change its PCC rules as a result of a dependency check. This may be useful to tell the network that in cases of conflict, this PDU session should not be modified to help address the conflict. The PDU session conflict assistance information may also provide a list of PDU session IDs that are already active for the WTRU. The PDU session conflict assistance information may also provide an indication to the PCF to perform a dependency check for this PDU session.

Alternatively, this first message can be a PDU session modification request message.

The AMF (211) may use the DNN and S-NSSAI to select an SMF to serve the PDU Session. The SMF may select a PCF to serve the PDU Session and may initiate a SM Policy Association Establishment procedure with the selected PCF. One purpose of the SM Policy Association Establishment procedure is for the SMF to obtain PCC Rules from the PCF. When the SMF invokes the SM Policy Association Establishment service, the SMF may provide the PDU session conflict assistance information. For example, the identity of a CRF, information that can be used to determine the identity of the CRF, and the preference level indication of the PDU Session.

The SMF that is selected in this step may be called SMF-A. The PCF that is selected in this step may be called PCF-A.

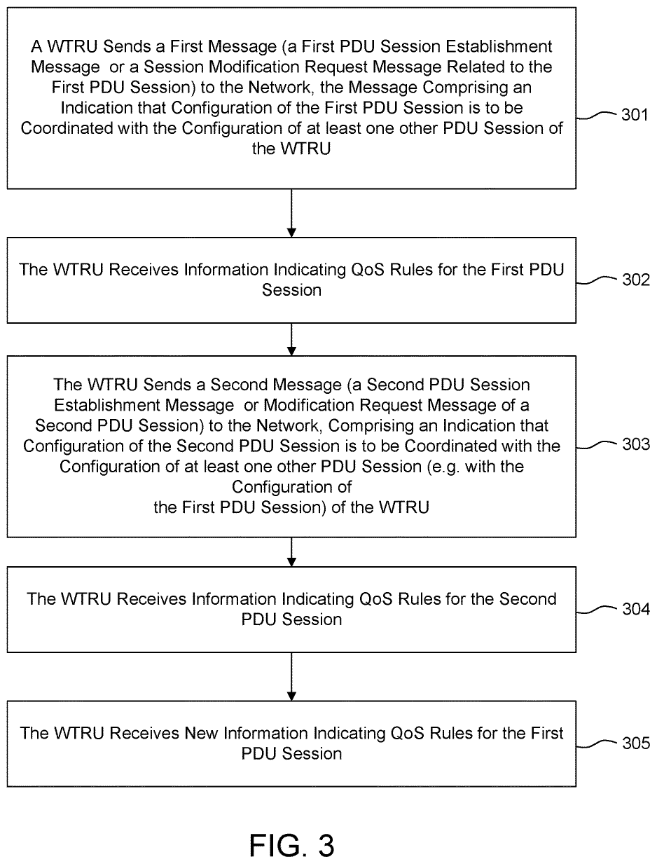

In step 202, performs step 7b of the WTRU Requested PDU Session Establishment procedure as in section 4.3.2.2.1 of 3GPP TS 23.502, Release 18 (V18.1.0), which includes once the SM policy association creation procedure has taken place, SMF-A allocates addresses like IP address and selects the UPF that is going to serve the UE to connect to the DN. The SMF-A sends the QoS Flow Indicator (QFI) to UPF. The UPF creates a tunnel endpoint ID and sends the information back to the SMF-A. The SMF-A sends an N1N2 Message to the AMF which contains both N1 and N2 messages destined for the UE and gNB, respectively the NI message is the PDU session establishment accept message. An SM Policy Association Establishment procedure is performed in this step 202. PCF-A will determine a first set of PCC Rules in the SM Policy Association Establishment procedure. According to an embodiment, the SM Policy Association Establishment is enhanced so that PCF-A sends a first set of PCC Rules to the CRF and receives new information from the CRF. The new information may be used by PCF-A to determine a second set of PCC Rules. The second set of PCC Rules may be what is provided to SMF-A in the SM Policy Association Establishment response. The second set of PCC Rules may be the same as the first set of PCC Rules. The interaction between PCF-A and CRF may be called a dependency check and is detailed further in the procedure of FIG. 3.

Alternatively, this first message can be a PDU session modification request.

In this example procedure, since the WTRU has not yet established any PDU Session, the CRF may reply to PCF-A with an indication that the PCC Rules that were provided by PCF-A to the CRF are suitable. These PCC Rules would not be in conflict with any other PCC Rules since no other PDU Session is established.

In step 203, the PDU session establishment procedure completes. This step maps the steps 8 to 21 of the WTRU Requested PDU Session Establishment procedure in section 4.3.2.2.1 of 3GPP TS 23.502, Release 18 (V18.1.0): the WTRU sends a PDU session establishment request message to the 5GS, i.e., AMF; when the AMF receives the WTRU request, it performs an SMF selection to select the SMF-B that will serve the WTRU for the PDU session; the SMF-B will then perform a PCF selection based on information provided by the WTRU such as the S-NSSAI/DNN combination. At this point the SMF is about to start an SM policy association establishment procedure with the PCF-B.

In step 204, the WTRU and network begin to perform a second PDU session establishment procedure. The second PDU session establishment procedure is initiated so that the WTRU can access service B. This step maps the steps 1 to 7a of the WTRU Requested PDU Session Establishment procedure in section 4.3.2.2.1 of 3GPP TS 23.502, Release 18 (V18.1.0): once the SM policy association creation procedure has taken place, SMF-B then allocates addresses like IP address and selects the UPF that is going to serve the WTRU to connect to the DN. The SMF-B sends the QoS Flow Indicator (QFI) to UPF. The UPF creates a tunnel endpoint ID and sends the information back to the SMF-B. The SMF-B sends an N1N2 Message to the AMF which contains both N1 and N2 messages destined for the WTRU and gNB, respectively the N1 message is the PDU session establishment accept message.

The WTRU may include information in the PDU Session Establishment Request such as a second DNN and a second S-NSSAI that is associated with the second PDU Session and associated with accessing service B. The AMF will use the second DNN and second S-NSSAI to select an SMF to serve the second PDU Session. The SMF will select a PCF to service the second PDU Session and will initiate a SM Policy Association Establishment procedure with the selected PCF. One purpose of the SM Policy Association Establishment procedure is for the SMF to obtain PCC Rules from the PCF. The WTRU may also include the identity of a CRF or a parameter that can be used to determine an identity of a CRF in the PDU Session Establishment Request. The WTRU may also include a preference level indication that indicates the preference level of the PDU Session. The preference level may indicate the priority of the PDU Session relative to the PDU Session that was established in step 201. Alternatively, the preference level may be a priority value (for example, a numeric value or a relative priority indication such as “low”, “medium”, or “high”). The PDU session conflict assistance information may also provide an indication if the network may change its PCC rules as a result of a dependency check. This may be useful to tell the network that in cases of conflict, this PDU session should not be modified to help address the conflict. The PDU session conflict assistance information may also provide a list of PDU session IDs that are already active for the WTRU. The PDU session conflict assistance information may also provide an indication to the PCF to perform a dependency check for this PDU session.

The SMF that is selected in this step may be called SMF-B. The PCF that is selected in this step may be called PCF-B. When the SMF invokes the SM Policy Association Establishment service of the selected PCF, the SMF may provide the PCF with the identity of a CRF, information that can be used to determine the identity of the CRF, and the preference level indication of the PDU Session. The WTRU may determine the preference level of the PDU Session based on information that is received from an application via an AT Command or graphical user interface. Alternatively, the WTRU may determine a preference level for the PDU session, be setting this value to the Priority Level associated with the PDU session's QoS flow that has the highest priority.

In step 205, PCF-B performs step 7b of the WTRU Requested PDU Session Establishment procedure in section 4.3.2.2.1 of 3GPP TS 23.502, Release 18 (V18.1.0) similar to as set forth in step 202 for PCF-A. An SM Policy Association Establishment procedure is performed in step 205. The PCF will determine a set of PCC Rules in the SM Policy Association Establishment procedure. As described above, it is proposed that the SM Policy Association Establishment be enhanced so that PCF-B sends a third set of PCC Rules to the CRF and receives additional information from the CRF. The additional information may be used by PCF-B to determine a fourth set of PCC Rules. The fourth set of PCC Rules may be the same as the third set of PCC Rules. The fourth set of PCC Rules may be what is provided to SMF-B in the SM Policy Association Establishment procedure. The interaction between PCF-B and CRF may be called a dependency check and is detailed further in the procedure of FIG. 3.

In this procedure, since the WTRU already has an established any PDU Session, the CRF may reply to PCF-B with:
an indication that the PCC Rules that were provided by PCF-B to the CRF are not suitable;
with information that PCF-B can use to derive a new set of PCC Rules that are suitable (e.g., the information may be an alternative set of PCC rules); or
an indication that the PCC Rules that were provided by PCF-B to the CRF are suitable.

The CRF may also be triggered to send a notification to PCF-A to notify PCF-A that the PCC Rules that are being applied by PCF-A are no longer suitable. This notification may also include information that PCF-A can use to derive a new set of PCC Rules that are suitable (e.g., the information may be an alternative set of PCC rules).

In step 206, the second PDU session establishment procedure completes. This step maps the steps 8 to 21 of the WTRU Requested PDU Session Establishment procedure in section 4.3.2.2.1 of 3GPP TS 23.502, Release 18 (V18.1.0) as set forth in step 203.

As an alternative to the WTRU supplied preference level, the PCF may also determine a priority value for a PDU session, based on the Priority Level of the PDU session's QoS flow with the highest priority.

FIG. 3 is a flowchart of a WTRU that indicates that a dependency check is required for a PDU session. A WTRU may perform the following actions:

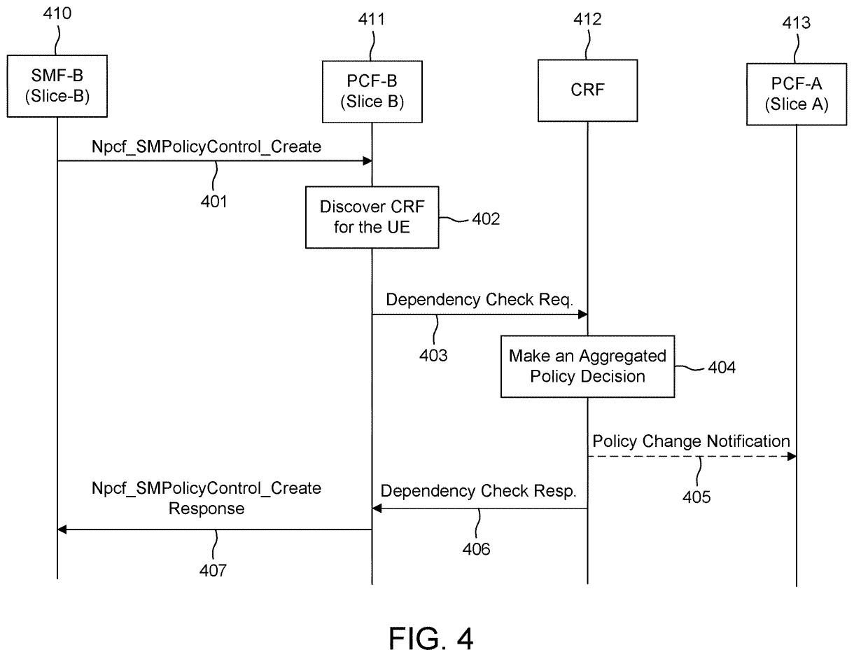

In 301, the WTRU sends (see also FIG. 2—step 201 and FIG. 4 step 401; step 401 is a message that comes as a result of message sent by the WTRU in step 303) a first message/request to the network (e.g., to the AMF). This message/request can be a PDU session establishment or modification request message. The first message/request includes an indication that configuration of the PDU Session should be coordinated with the configuration of other PDU Sessions of the WTRU.

The first message/request may also include the identity of a CRF or a parameter that can be used to determine an identity of a CRF.

The first message/request may also include a first preference level indication, wherein the second preference level indication indicates the preference level of the first PDU Session.

The preference level indication may be determined based on information that is received from an application (e.g., via an AT Command or a Graphical User Interface).

In 302, (see also FIG. 2—step 203) the WTRU receives QoS rules for the first PDU Session.

In 303, (see also FIG. 2—step 205 and FIG. 4 step 401) the WTRU sends a second message/request to the network (i.e., AMF). This second message/request can be a PDU session establishment or modification request message. The second message/request includes the indication that configuration of the PDU Session may be coordinated with the configuration of other PDU Sessions of the WTRU.

The second message/request may also include the identity of a CRF or a parameter that may be used to determine an identity of a CRF.

The second message/request may also include a second preference level indication, wherein the second preference level indication indicates the preference level of the second PDU Session relative to other PDU Sessions of WTRU.

In 304, (see also FIG. 2—step 206) the WTRU receives QoS rules for the second PDU Session.

In 305, (see also FIG. 4—step 405 (a message that precedes the message sent to the WTRU in step 305)) the WTRU receives new QoS rules for the first PDU Session.

### Dependency Check Between Two XRM Services: Dependency Check Functionality

FIG. 4 shows an example SM Policy Association Establishment procedure that has been enhanced so that the PCF sends PCC rules to the CRF to check if the PCC Rules conflict with services thar are consumed by the WTRU in other slices. In the example of FIG. 4, the procedure is initiated by SMF-B (410) and thus represents an example of what may occur in step 205 of FIG. 2. It should be appreciated that a similar procedure may take place in step 202 of FIG. 2 with SMF-A and PCF-A. However, PCF-B would not take part in step 202 of FIG. 2 since the second PDU Session would not have been established when step 202 of FIG. 2 takes place.

In 401, PCF-B (411) receives a Session Management policy association create message (e.g., a Npcf_SMPolicyControl_Create request) from SMF-B (410).

PCF-B may use information from the Npcf_SMPolicyControl_Create request to determine a third set of PCC Rules (note that “First” and “second” are related to PCF-A in section “Coordination between two services”. Throughout the disclosure, this set of PCC rules is a “third” set of PCC rules. For PCF-B this is the first set of PCC rules). PCF-B may determine that the PCC Rules need to be checked with a CRF (412) to see if they will conflict with PCC rules that are in use by other PDU Sessions of the WTRU. The focus is on a specific UE or WTRU, so the coordination is taking place here per WTRU. The coordination function receives information from the PCFs that provides the WTRU in question, the PDU session ID, the serving PCF for the PDU session, and for example the PCC rules related to this PDU session for this WTRU. In the request the PCF includes the WTRU identity in question, for whom the PCC rules are considered.

PCF-B may determine that the PCC Rules need to be checked based on the S-NSSAI and DNN combination of the PDU Session. For example, the PCF may be configured to always check for PCC Rule conflicts for PDU Sessions that are associated with certain DNN and S-NSSAI combinations.

PCF-B may determine that the PCC Rules need to be checked based on an indication that the SMF included, in the Npcf_SMPolicyControl_Create request. For example, the SMF may have been configured to always request that the PCF check the PCC Rule for conflicts when PDU Sessions that are associated with certain DNN and S-NSSAI combinations. Alternatively, the SMF may have used information in the PDU Session Establishment Request to determine to request that the PCF check the PCC Rules for conflicts with other PDU Sessions that are associated the WTRU. For example, the PDU Session Establishment Request that was sent by the WTRU to the SMF may have indicated that the PDU Session is for high priority services or indicated that the configuration of the PDU Session should be coordinated with other PDU Sessions of the WTRU. The information in the PDU Session Establishment request may be what the SMF uses to determine to perform the checking operation. The PDU Session Establishment from the WTRU request may have also included an identifier that is sent by the SMF to the PCF and used by the PCF to determine, or discover, the identity of the CRF.

PCF-B may determine that the PCC Rules need to be checked based on an indication that is received from the UDR. For example, the WTRU's subscription information that is provided by the UDR to PCF-B may indicate that the PCF should check the PCC Rule for conflicts for PDU Sessions that are associated with certain DNN and S-NSSAI combinations.

In 402, based on the determination that was made in step 401, PCF-B will perform a procedure to discover the CRF that PCF-B should contact.

PCF-B may discover the CRF by querying the NRF to retrieve the Identifier of the CRF function. For example, PCF-B may invoke the Nnrf_NFDiscovery service and include the WTRU's SUPI in the query.

PCF-B can discover the CRF by retrieving the WTRU's subscription information from the UDR, for example by using the Nudr_DM_subscribe or Nudr_DM_query service operations.

PCF-B can discover the CRF based on information that was included in the Npcf_SMPolicyControl_Create request. For example, SMF-B may have provided the CRF ID to PCF-B. SMF-B may have obtained the CRF ID based on provisioning or from the AMF during an Nsmf PDUSession_CreateSMContext service invocation.

PCF-B can discover the CRF by querying the BSF and receiving an identifier of the CRF from the BSF. For example, the CRF may have previously registered with the BSF to indicate that it is associated with a PDU Session of the WTRU.

In 403, PCF-B sends a dependency check request to the CRF (412). The dependency check request includes the PCC Rules that were determined in 401 and an identifier of the WTRU (e.g., SUPI). The request may also include a DNN, S-NSSAI or PDU Session ID. The DNN, S-NSSAI and/or PDU Session ID may be used to identify the PDU Session ID. The request may also include a preference level of the PDU Session.

The CRF may store information/context regarding the PCFs such as (PCF ID, DNN, S-NSSAI, PDU session ID, WTRU identifier).

In 404, the CRF makes an aggregated policy decision.

The CRF makes an aggregated policy decision by checking if it has received PCC Rules for other PDU Sessions of the WTRU and then make any combination of the following decisions.

If the CRF does not have PCC Rules stored for other PDU Sessions of the WTRU, then the CRF may determine that the PCC Rules that were sent by PCF-B are acceptable.

If the CRF does have PCC Rules stored for other PDU Sessions of the WTRU, then the CRF may determine that the PCC Rules that were provided by PCF-B conflict with the PCC Rules that are stored for other PDU Sessions of the WTRU.

If the CRF determined that the PCC Rules that were provided by PCF-B conflict with the PCC Rules that are stored for other PDU Sessions of the WTRU, then the CRF may determine a new set of PCC Rules for PCF-B that will not conflict with the PCC Rules of other PDU Sessions of the WTRU.

If the CRF determined that the PCC Rules that were provided by PCF-B conflict with the PCC Rules that are stored for other PDU Sessions of the WTRU, then the CRF may determine a new set of PCC Rules for one or more of the other PDU Sessions of the WTRU (e.g., the PDU Session that is served by PCF-A).

If the CRF does determine that there is a conflict between the PCC Rules of two or more PDU Sessions, then the CRF may determine which PDU Session to prioritize based on the Preference level that was received from the PCF. The preference level indicates which service the user of the WTRU downgrade in the event that the quality of experience of one service needs to be downgraded. If no preference level is indicated, then the CRF can choose to downgrade either of the services A or B. The CRF can choose to uniformly downgrade the services (meaning, on one occurrence it can downgrade service A, on the next occurrence of conflict, it can choose to downgrade service B).

In 405, if the CRF determined a new set of PCC Rules for one or more of the other PDU Sessions of the WTRU, then the CRF will send PCC Rules to the PCF(s) (e.g., PCF-A 413) that serve the other PDU Session(s) of the WTRU. For example, new PCC Rules may be sent to PCF-A. The PCF may send the new PCC Rules to the SMF and reception of the new PCC Rules may trigger the SMF to create new QoS Rules, N4 Rules, and a QoS Profile for PDU Session A. If new QOS Rules are created, a PDU Session Modification procedure may be used by the SMF to send the new QoS Rules to the WTRU. If the CRF did not determine a new set of PCC Rules for one or more of the other PDU Sessions of the WTRU, then this step may be skipped.

When there is an update in the PCC rules, the PCF may send a notification to the application function.

In 406, the CRF may reply to PCF-B. The reply to PCF-B may:
indicate that the PCC Rules that were provided in step 403 are acceptable and may be used by the PCF; or indicate that the PCC Rules that were provided in step 403 are not acceptable and that PCF-B should generate new PCC Rules, thus triggering the PCF to initiate a new Npcf_SMPolicyControl_Create procedure; or
indicate that the PCC Rules that were provided in step 403 are not acceptable and indicate a set of PCC Rules that are acceptable; or
indicate a set of PCC Rules that are acceptable.

In 407, PCF-B may respond to the SMF with a set of PCC Rules. The PCC Rules that are provided by PCF-B to the SMF may be the PCC Rules that PCF-B determined in step 401 or the PCC Rules that were provided to PCF-B by the CRF in step 406.

The procedure of FIG. 4 explains how the PCF may send a set of PCC Rules to the CRF to be checked by the CRF. Alternatively, the PCF may provide Service Parameters to the CRF. The CRF may check the Service Parameters for conflicts and then indicate to the PCF if the Service Parameters are acceptable or need to be adjusted. The CRF may also suggest new Service Parameters to the PCF. The PCF may then use Service Parameters that are determined to be acceptable to determine a set of PCC Rules. The PCC Rules may then be sent to the PCF (e.g., in step 407).

Alternatively, the PCF may have received Alternative Service Requirements, containing one or more QoS reference parameters or Alternative QoS Related parameter sets, for example, from an application function via an AF session with required QoS procedure which first sends these parameters to the NEF and then the NEF provides these parameters to the PCF via Npcf_Policy Authorization_Create service.

In this case, the PCF may provide these Alternative QoS related parameters sets to the CRF in the dependency request message. The CRF may check the QoS parameters together with the Alternative QoS related parameters for conflict and indicate to the PCF which of these parameters set(s) are acceptable to be used.

Additionally, the PCF may use the QoS parameters and the alternative QoS related parameters sets to generate a PCC rule and alternative PCC rules for the service in question, and then the PCF includes these PCC rules in the dependency check request sent to the CRF. Then, the CRF may check these PCC rules and indicate to the PCF which of these rules are acceptable.

In the last two examples, the PCF may be triggered to check for dependencies between PCC rules and policies by an invocation of the Npcf_Policy Authorization service from the NEF (after the NEF for example receives an Nnef_AFsessionwithRequiredQoS request from the AF).

Once the multiple PDU sessions over the different network slices have been established, a WTRU may also determine that it can no longer sustain these multiple PDU sessions. This may be determined based on poor QoE for the user and provided to WTRU through a graphical user interface. Alternatively, this may be determined by an application and provided to the WTRU via an AT Command. Alternatively, this may be determined at the AS layer or NAS layer based on performance monitoring at the QoS flow level. Alternatively, this may be determined at the NAS layer based on performance monitoring at the SDF level. Once the WTRU makes this determination, it may request that its PCC rules be modified to compensate for the conflict. For example, the WTRU may send a PDU Session Modification Request on one or more of the multiple PDU sessions. The PDU Session Modification Request may include:
an indication of the conflict;
an indication of which PDU session should be modified;
an indication of how to modify the PCC rules. For example, this may be an indication to reduce the guaranteed DL bandwidth by K %.

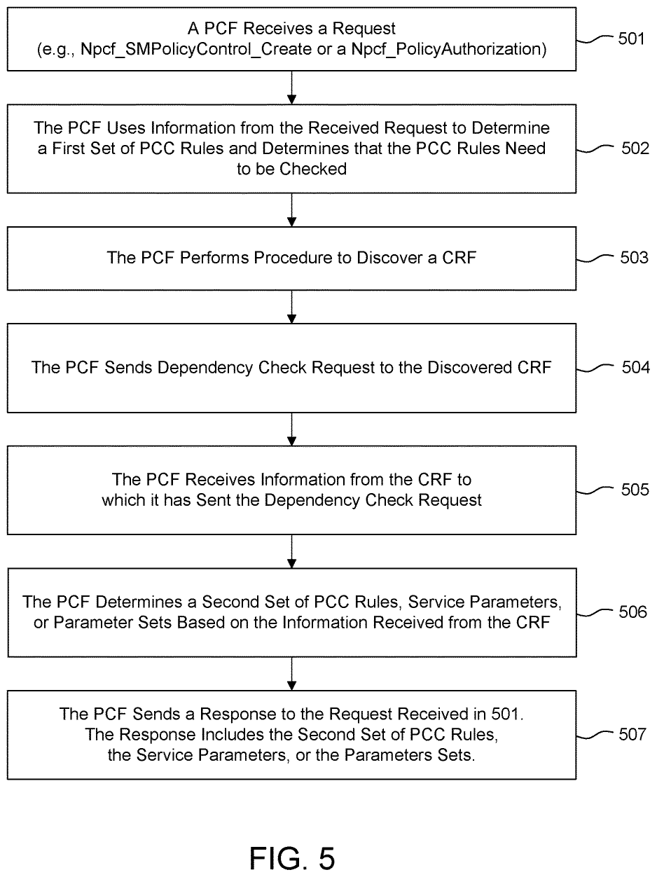

FIG. 5 is a flow chart of a method according to an embodiment, wherein a PCF performs a dependency check on PCC rules, service parameters, or parameter sets. A PCF may perform the following actions:

In 501, the PCF (see also FIG. 4—step 401) receives a request.

According to an embodiment, the request is a Npcf_SMPolicyControl_Create request from the SMF.

According to an embodiment, the request is a Npcf_Policy Authorization request from the NEF.

In 502, the PCF (see also FIG. 4—step 401) uses information from the request to determine a first set of PCC Rules and determines that these rules need to be checked. According to embodiments, this determination may for example be based on:
the S-NSSAI and DNN combination of the PDU Session upon configuration in step 501;
an indication in the request;
an indication that is received from the UDR that a PDU Session is associated with the S-NSSAI and DNN combination.

In 503, (see also FIG. 4—step 402) the PCF performs a procedure to discover the CRF.

The discovery procedure may be based on querying the NRF to retrieve the Identifier of the CRF function. For example, PCF-B may use invoke the Nnrf_NFDiscovery service and include the WTRU's SUPI in the query.

The discovery procedure may be based on retrieving the WTRU's subscription information from the UDR, for example by using the Nudr_DM_subscribe or Nudr_DM_query service operations.

The discovery procedure may be based on based on information that was included in the request. For example, SMF or NEF may have provided the CRF ID to PCF.

The discovery procedure may be based on querying the BSF and receiving an identifier of the CRF from the BSF.

The discovery procedure may be based on local configuration in the PCF.

In 504, (see also FIG. 2—step 202 and FIG. 4 step 403) the PCF sends a dependency check request to the CRF. The dependency check request may include an identifier of the WTRU (e.g., a SUPI) and at least one of:
the first set PCC Rules;
service Parameters; and
alternative QoS related parameters sets; or
a set of alternative PCC rules with derived from alternative QoS related parameters.

In 505, (FIG. 2—steps 202 and 205, and FIG. 4 step 406) the PCF receives information from the CRF. According to embodiments, this information may include:
an indication that the PCC Rules, service Parameters, or parameter sets that were provided in the dependency check request are acceptable and may be used by the PCF;
an indication that the PCC Rules, service Parameters, or parameter sets that were provided in the dependency check request are not acceptable;
an indication that the PCF should generate new PCC Rules, service Parameters, or parameter sets; and
a set of PCC Rules, service Parameters, or parameter sets that are acceptable.

In 506, (see also FIG. 2—steps 202 and 205, and FIG. 4—steps 405 and 406) the PCF may determine a second set of PCC rules, service Parameters, or parameter sets based on information received from the CRF.

In 507, (see also FIG. 2—steps 203 and 206, and FIG. 4—step 407) the PCF sends a response that includes the second set of PCC rules, service Parameters, or parameter sets.

The response may be a response to the Npcf_SMPolicyControl_Create request from the SMF.

The response may be a response to the Npcf_Policy Authorization request from the NEF.

According to an embodiment, there is disclosed a method, implemented by a policy control function (PCF).

The method may include, in 501, receiving a request and determining a set of policy charging and control rules from information comprised in the request.

The method may include, in 502, based on information comprised in the request, determining that the set of policy charging and control rules are to be checked with a coordination function. This is to determine whether the set of policy charging and control rules conflict with policy charging and control rules used by other protocol data unit sessions of a wireless transmit-receive unit.

The method may include, in 503, discovering a coordination function.

The method may include, in 504, transmitting, to the coordination function, a dependency check request comprising the set of policy charging and control rules.

The method may include, in 505 and 506, receiving, from the control function, information comprising a new set of policy charging and control rules for at least one of the other protocol data unit sessions of the WTRU.

The method may include, in 507, transmitting, in reply to the request received, the new set of policy charging and control rules for at least one of the other protocol data unit sessions of the WTRU.

According to an embodiment of the method implemented by the PCF, the information comprised in the request comprises information related to a protocol data unit session and single network slice selection assistance information and data network name of the protocol data unit session, the policy control function determining that the set of policy charging and control rules are to be checked with a coordination function based on a single network slice selection assistance information and data network name combination of the protocol data unit session.

According to an embodiment of the method implemented by the PCF, the information comprised in the request may comprise an indication that the set of policy charging and control rules are to be checked with a coordination function to determine whether the set of policy charging and control rules conflict with policy charging and control rules used by other protocol data unit sessions of the wireless transmit-receive unit.

According to an embodiment of the method implemented by the PCF, the information comprised in the request may comprise in indication received from a unified data repository that a protocol data unit session is associated with the single network slice selection assistance information and data network name combination.

According to an embodiment of the method implemented by the PCF, the request may be one of: a policy control create request received from a session management function; a policy authorization request received from a network exposure function.

According to an embodiment of the method implemented by the PCF, the discovering the coordination function may be based on querying a network repository function to retrieve an identifier of the coordination function.

According to an embodiment of the method implemented by the PCF, a query for querying the network repository function may comprise the subscription permanent identifier of the wireless transmit-receive unit.

According to a further aspect, there is disclosed a policy control function device comprising at least one processor. The at least one processor may be configured to:
receive a request and determine a set of policy charging and control rules from information comprised in the request;
based on information comprised in the request, determine that the set of policy charging and control rules are to be checked with a coordination function to determine whether the set of policy charging and control rules conflict with policy charging and control rules used by other protocol data unit sessions of a wireless transmit-receive unit;
discover a coordination function;
transmit, to the coordination function, a dependency check request that may comprise the set of policy charging and control rules;
receive, from the control function, information that may comprise a new set of policy charging and control rules for at least one of the other protocol data unit sessions of the WTRU; and
transmit, in reply to the request received, the new set of policy charging and control rules for at least one of the other protocol data unit sessions of the WTRU.

According to an embodiment of the PCF device, the information that may be comprised in the request may comprise information related to a protocol data unit session and single network slice selection assistance information and data network name of the protocol data unit session, the policy control function determining that the set of policy charging and control rules are to be checked with a coordination function based on a single network slice selection assistance information and data network name combination of the protocol data unit session.

According to an embodiment of the PCF device, the information that may be comprised in the request may comprise an indication that the set of policy charging and control rules are to be checked with a coordination function to determine whether the set of policy charging and control rules conflict with policy charging and control rules used by other protocol data unit sessions of the wireless transmit-receive unit.

According to an embodiment of the PCF device, the information that may be comprised in the request may comprise in indication received from a unified data repository that a protocol data unit session is associated with the single network slice selection assistance information and data network name combination.

According to an embodiment of the PCF device, the request may be one of: a policy control create request received from a session management function; a policy authorization request received from a network exposure function.

According to an embodiment of the PCF device, the discovery of the coordination function may be based on querying a network repository function to retrieve an identifier of the coordination function.

According to an embodiment of the PCF device, a query for querying the network repository function may comprise the subscription permanent identifier of the wireless transmit-receive unit.

According to an embodiment, there is disclosed a method, implemented by a wireless transmit-receive unit (WTRU).

The method may include, in 301, transmitting a first message to a network, the first message relating to a first protocol data unit session. The first message comprises an indication that a configuration of the first protocol data unit session is to be coordinated with configuration of at least one other protocol data unit session of the WTRU.

The method may include, in 302, receiving in response to the first message, information indicating first quality of service rules for the first protocol data unit session.

The method may include, in 303, transmitting a second message to the network. The second message including an indication that a configuration of a second protocol data unit session is to be coordinated with configuration of at least one other protocol data unit session of the WTRU.

The method may include, in 304, receiving, in response to the second message, information indicating second quality of service rules for the second protocol data unit session.

The method may include, in 305, receiving, in response to the second message, updated information indicating first quality of service rules for the first protocol data unit session.

According to an embodiment of the method implemented by the WTRU, the first protocol data unit session and the second protocol data unit session are related to services of a same WTRU application.

According to an embodiment of the method implemented by the WTRU, the first message may be one of: a protocol data unit session establishment message or a protocol data unit session modification message.

According to an embodiment of the method implemented by the WTRU, the first message may comprise at least one of: an identifier of a coordination function, or a parameter identifying a coordination function.

According to an embodiment of the method implemented by the WTRU, the first message may comprise a first preference level indication indicating a preference level of the first protocol data unit session, the preference level being a priority value associated with a quality of service flow of the first protocol data unit session.

According to an embodiment of the method implemented by the WTRU, the second message may be one of: a protocol data unit session establishment message or a protocol data unit session modification message.

According to an embodiment of the method implemented by the WTRU, the second message may comprise at least one of: an identifier of a coordination function, a parameter identifying a coordination function.

According to an embodiment of the method implemented by the WTRU, the second message may comprise a second preference level indication indicating a preference level of the second protocol data unit session, the preference level for example being a priority value associated with a quality of service flow of the second protocol data unit session.

According to an embodiment, there is disclosed a wireless transmit-receive unit, WTRU, comprising at least one processor. The at least one processor may be configured to:
transmit a first message to a network, the first message relating to a first protocol data unit session, comprising an indication that a configuration of the first protocol data unit session is to be coordinated with configuration of at least one other protocol data unit session of the WTRU;
receive, in response to the first message, information indicating first quality of service rules for the first protocol data unit session;
transmit a second message to the network, the second message may comprise an indication that a configuration of a second protocol data unit session is to be coordinated with configuration of at least one other protocol data unit session of the WTRU;
receive, in response to the second message, information indicating second quality of service rules for the second protocol data unit session; and receive, in response to the second message, updated information indicating first quality of service rules for the first protocol data unit session.

According to an embodiment of the WTRU, the first protocol data unit session and the second protocol data unit session are related to services of a same WTRU application.

According to an embodiment of the WTRU, the first message may be one of: a protocol data unit session establishment message or a protocol data unit session modification message.

According to an embodiment of the WTRU, the first message may comprise at least one of: an identifier of a coordination function, a parameter identifying a coordination function.

According to an embodiment of the WTRU, the first message may comprise a first preference level indication indicating a preference level of the first protocol data unit session, the preference level for example being a priority value associated with a quality of service flow of the first protocol data unit session.

According to an embodiment of the WTRU, the second message may be one of: a protocol data unit session establishment message or a protocol data unit session modification message.

According to an embodiment of the WTRU, the second message may comprise at least one of: an identifier of a coordination function, a parameter identifying a coordination function.

According to an embodiment of the WTRU, the second message may comprise a second preference level indication indicating a preference level of the second protocol data unit session, the preference level for example being a priority value associated with a quality of service flow of the second protocol data unit session.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 16 or means-plus-function claim format, and any claim without the terms “means for” is not so intended.

1. A method, implemented by a wireless transmit-receive unit, comprising:
transmitting a first message to a network, the first message relating to a first protocol data unit session and comprising an indication that a first configuration of the first protocol data unit session is to be coordinated with at least one other configuration of at least one other protocol data unit session of the wireless transmit-receive unit, and the first message comprising a first preference level of the first protocol data unit session, the first preference level being a priority value associated with a quality of service flow of the first protocol data unit session;
receiving, in response to the first message, information indicating one or more first quality of service rules for the first protocol data unit session;
transmitting a second message to the network, the second message comprising an indication that a second configuration of a second protocol data unit session is to be coordinated with the at least one other configuration;
receiving, in response to the second message, information indicating one or more second quality of service rules for the second protocol data unit session; and
receiving, in response to the second message, updated information indicating the one or more first quality of service rules for the first protocol data unit session.

2. The method according to claim 1, wherein the first protocol data unit session and the second protocol data unit session are related to services of a same WTRU application.

3. The method according to claim 1, wherein the first message is one of: a protocol data unit session establishment message or a protocol data unit session modification message.

4. The method according to claim 1, wherein the first message comprises one of: an identifier of a coordination function, or a parameter identifying a coordination function.

5. (canceled)

6. The method according to claim 1, wherein the second message is one of: a protocol data unit session establishment message or a protocol data unit session modification message.

7. The method according to claim 1, wherein the second message comprises one of: an identifier of a coordination function, or a parameter identifying a coordination function.

8. The method according to claim 1, wherein the second message comprises a second preference level indication indicating a preference level of the second protocol data unit session, the preference level being a priority value associated with a quality of service flow of the second protocol data unit session.

9. A wireless transmit-receive unit comprising at least one processor, the at least one processor being configured to:
transmit a first message to a network, the first message relating to a first protocol data unit session and comprising an indication that a first configuration of the first protocol data unit session is to be coordinated with at least one other configuration of at least one other protocol data unit session of the wireless transmit-receive unit, and the first message comprising a first preference level of the first protocol data unit session, the first preference level being a priority value associated with a quality of service flow of the first protocol data unit session;
receive, in response to the first message, information indicating one or more first quality of service rules for the first protocol data unit session;
transmit a second message to the network, the second message comprising an indication that a second configuration of a second protocol data unit session is to be coordinated with the at least one other configuration;
receive, in response to the second message, information indicating one or more second quality of service rules for the second protocol data unit session; and
receive, in response to the second message, updated information indicating the one or more first quality of service rules for the first protocol data unit session.

10. The wireless transmit-receive unit according to claim 9, wherein the first protocol data unit session and the second protocol data unit session are related to services of a same WTRU application.

11. The wireless transmit-receive unit according to claim 9, wherein the first message is one of: a protocol data unit session establishment message or a protocol data unit session modification message.

12. The wireless transmit-receive unit according to claim 9, wherein the first message comprises one of: an identifier of a coordination function, or a parameter identifying a coordination function.

13. (canceled)

14. The wireless transmit-receive unit according to claim 9, wherein the second message is one of: a protocol data unit session establishment message or a protocol data unit session modification message.

15. The wireless transmit-receive unit according to claim 9, wherein the second message comprises one of: an identifier of a coordination function, or a parameter identifying a coordination function.
